(19) United States
(12) Patent Application Publication
(10) Pub. No.: US 2013/0204871 A1
(43) Pub. Date: Aug. 8, 2013

(54) METHOD AND APPARATUS FOR SOCIAL CONTENT CURATION AND RANKING

(71) Applicant: Glam Media, Inc., Brisbane, CA (US)

(72) Inventor: Stanley Wong, Palo Alto, CA (US)

(73) Assignee: Glam Media, Inc., Brisbane, CA (US)

(21) Appl. No.: 13/763,124

(22) Filed: Feb. 8, 2013

Related U.S. Application Data
(60) Provisional application No. 61/596,359, filed on Feb. 8, 2012.

(51) Int. Cl. G06F 17/30

(52) U.S. Cl. CPC G06F 17/30867
USPC 707/732

(57) ABSTRACT

A method and apparatus for ranking documents obtained in a search. The document rank is determined based on social engagement data for each document. The number of social sharing events for the document are summed then normalized to generate a quality score for determining rank. Various weighting factors may be applied to derive the quality score.

### CROSS REFERENCE

This disclosure claims priority from U.S. Provisional Patent App. No. 61/596,359 entitled Computer-Implemented Social Content Curation and Rating, filed Feb. 8, 2012, and incorporated herein by reference.

### TECHNICAL FIELD

The present invention relates to methods and systems for searching and retrieving relevant information from information resources, and more particularly, for ranking the search results on the basis of social engagement data.

### BACKGROUND

Content creators or authors have the power to create, publish and reach millions of consumers through the World Wide Web. Content is being produced on the Web in greater amounts ever before. As a result, consumers are overwhelmed with too many choices, too much content and too much noise vying for their attention, making it very difficult to sort out what is important and what is not.

Web portals try to aggregate and present content obtained using search engine technology in a uniform manner. However, such sites are largely ineffective as the most important content relative to a user's query is likely scattered across hundreds of blogs and news sites.

Social networking has revolutionized the Web medium by connecting individuals via a social graph while enabling them to express their opinions, likes, and comments on things they care about, and share content with one another. Thus, such social activity can be a signal for active consumer engagement where consumers publically express and share their preferences for things that are important to them in some respect.

Further, with such large amounts of information being generated by content creators, social media and consumers, the need to organize, determine quality, rank and sort the information and its relative importance to the user's query is critical. Therefore, it would therefore be desirable to use social engagement data to more effectively rank the information obtained in response to a query.

### BRIEF DESCRIPTION OF THE DRAWINGS

FIGS. 1A-1C are block diagrams illustrating alternative computing environments in which to implement the disclosed subject matter.

FIG. 2 is a flow chart illustrating a process for using social engagement data to rank search results.

FIG. 3 is an example of a curated web page.

### DETAILED DESCRIPTION

1. Overview

A search engine is used to collect, store, index and rank objects, e.g., web pages, in response to user queries. Improved methods disclosed herein collect and apply social engagement data to rank the search results.

For example, the number of times that an item or object, represented as a URL on a computer network, is shared or discussed on a social network such as Facebook, can be indicative of the relevance of the object to the search terms. Thus, in one embodiment, this type of social engagement data is collected and factored into a scoring technique to rank documents. Further, such ranking can be used as the basis for providing curated collections of documents for the benefit of users.

More specifically, all the social media sharing events can be summed and then normalized to generate a ranking score. Further, each discrete sharing event can be weighted with one or more weighting factors. The weighting factors can include a sentiment score, a preference weight, an expert factor, or other relevant factors.

2. Hardware/Software Environment

The subject matter of this disclosure can be implemented in numerous ways, including as a process, an apparatus, a system, a computer-readable medium such as a computer readable storage medium or a computer network wherein program instructions are sent over optical or electronic communications links.

A detailed description of one or more embodiments and/or methods of the disclosed subject matter is provided below along with accompanying figures that illustrate the methods and principles of the invention. However, the disclosure is not limited to the described embodiments, and the order of method steps may generally be altered. Specific details are set forth in the following description in order to provide a thorough understanding of the disclosed subject matter and are provided only for the purpose of example and should not be considered limiting.

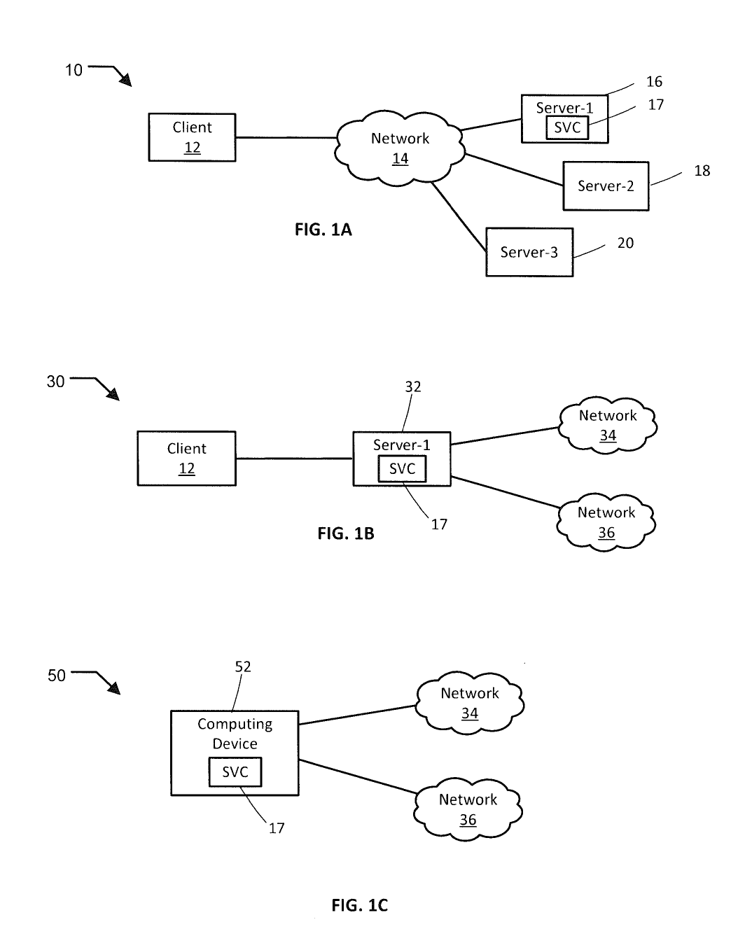

Referring to FIG. 1A, a computing environment 10 is illustrated. In this embodiment, a client computing device 12 is connected to a network 14 by a communications link. Further, various servers 16, 18, 20 are also connected to the network 14 by communications links. Server 16 has a ranking service 17 that ranks documents using social engagement data, as described herein. The client 12 is able to access and utilize the web service 17 through the network 14.

Referring to FIG. 1B, an alternative computing environment 30 is illustrated. In this embodiment, the client computing device 12 is connected to a server 32 by a communications link. Further, the server 32 is also connected to one or more networks, such as networks 34 and 36, by communications links. The networks 34, 36 may be connected to other networks, servers or other information resources. The ranking service 17 is resident on server 32, where it may be accessed directly by client 12.

Referring to FIG. 1C, another computing environment 50 is illustrated. In this embodiment, the computing device 52 may be considered either a client device or a server device. The computing device 52 is connected to one or more networks, such as networks 34 and 36, by communications links. The ranking service 17 is resident on computing device 52, where it may accessed and used.

Preferably, the ranking service 17 is implemented as computer-executable program instructions encoded on a computer-readable medium, which are executed by a general purpose computer or a specialized computer operating under the control of an operating system. In the context of this disclosure, a computer-readable medium may be any non-transitory medium that can contain or store the program instructions for use by or in connection with an instruction execution system, apparatus or device. For example, the computer-readable storage medium may be, but is not limited to, a random access memory (RAM), read-only memory (ROM), or a persistent store, such as a mass storage device, hard drives, CDROM, DVDROM, tape, erasable programmable read-only memory (EPROM or flash memory), or any magnetic, electromagnetic, infrared, optical, or electrical system, apparatus or device for storing information. Alternatively or additionally, the computer-readable storage medium may be any combination of these devices or even paper or another suitable medium upon which the program code is printed, as the program code can then be electronically captured, for instance, by optical scanning of the paper or other medium, then compiled, interpreted, or otherwise processed in a suitable manner, if necessary, and then stored in a computer memory.

Applications, software programs or computer-readable instructions may be referred to herein as components or modules or data objects or data items. Applications may be hardwired or hard-coded in hardware, or take the form of software executing on a general purpose computer such that when the software is loaded into and/or executed by the computer, the computer becomes an specialized apparatus for practicing embodiments of the disclosure. Applications may also be downloaded in whole or in part through the use of a software development kit or toolkit that enables the creation and implementation of an embodiment of the disclosure. In this specification, these implementations, or any other form that an embodiment of the disclosure may take, may be referred to as techniques. In general, the order of the steps of disclosed processes may be altered within the scope of the disclosure.

The techniques described herein may be used with computer systems having different configurations, e.g., with additional or fewer components or subsystems. For example, a computer system could include more than one processor (i.e., a multiprocessor system, which may permit parallel processing of information) or a system may include a cache memory. Other configurations of devices, systems and subsystems suitable for use will be readily apparent to one of ordinary skill in the art.

Computer software products may be written in any of various suitable programming languages, including C, C++, C#, Pascal, Fortran, Perl, Matlab (from MathWorks, www.mathworks.com), SAS, SPSS, JavaScript, CoffeeScript, Objective-C, Objective-J, Ruby, Python, Erlang, Lisp, Scala, Clojure, Java, and other programming languages. The computer software product may be an independent application with data input and data display modules. Alternatively, the computer software products may be classes that are instantiated as distributed objects. The computer software products may also be component software such as Java Beans (from Oracle) or Enterprise Java Beans (EJB from Oracle).

Examples of computer operating systems include one of the Microsoft Windows family of operating systems (e.g., Windows 95, 98, Me, Windows NT, Windows 2000, Windows XP, Windows XP x64 Edition, Windows Vista, Windows 7, Windows 8, Windows CE, Windows Mobile, Windows Phone 7), Linux, HP-UX, UNIX, Sun OS, Solaris, Mac OS X, Alpha OS, AIX, IRIX32, or IRIX64. Other operating systems may also be used.

3. Process for Ranking Search Results Using Social Engagement Data

Real life objects may be represented on computer networks (such as the Internet) by a Uniform Resource Locator (URL) or a set of URLs. For example, a favorite recipe may be represented by a single URL which points to an entry on a food blog. A restaurant may be represented by a set of URLs representing different web pages, for example, the home page of the restaurant, a menu page, a reservations page, a collection of reviews of the restaurant on sites like Yelp and/or Zagat, and links to other relevant web pages, such as Foursquare, OpenTable and Facebook.

Objects (i.e., URLs) may of course include a wide variety of products (e.g., automobiles, baby products, consumer electronics), locations (e.g., restaurants, venues), music (e.g., song or artist), television shows, and services (e.g., spa, stylist), to name but a few. For each URL, it is possible to query different social networks to obtain analytic data, such as the number of times a specified URL has been shared or discussed on the networks. For example, some of the more popular social networks include Facebook (Shares, Likes, Discussions), Twitter (Tweets, ReTweets), Google+ (+1s), Digg (Diggs), LinkedIn (Shares), Delicious, StumbleUpon (Stumbles), Reddit, and Pinterest (Pin count from button stats). For generality, all such data will be referred to as social sharing data or social engagement data for the purposes of this disclosure. This type of analytical information is available through the application program interface (API) of the social network, for example, the Insights API or Open Graph API for Facebook.

Thus, the processes described herein utilize this social engagement data to score the relevance of network objects identified in response to a user's query. Other active engagement signals may also be considered in scoring schemes, such as inbound links to the URL (e.g., from Blecko AIP), social check-ins (e.g., Foursquare API), clicks, video views, time spent, etc.

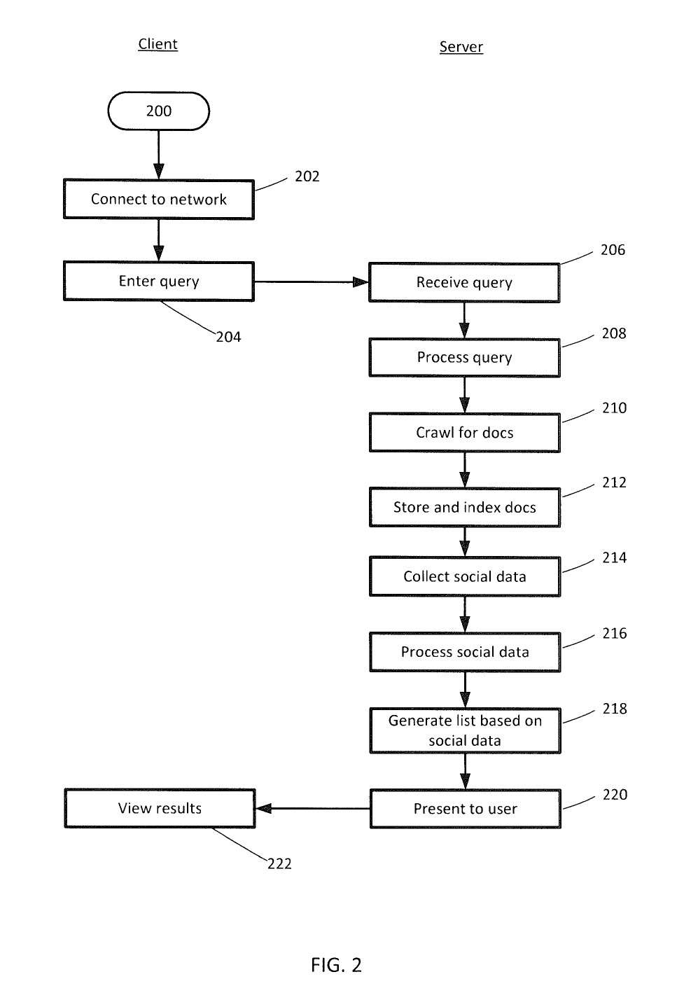

A process 200 for systematically ranking content using social engagement data is illustrated in FIG. 2. Process 200 is preferably implemented as a series of programmed software steps executed by a computing device, for example, in any of the configurations shown in FIGS. 1A-1C and described above, or in other variations. In a preferred implementation, a user has a local computing device (“client”) coupled to a remote web service (“server”), and the software steps are executed by the server and results delivered to the client. However, in other embodiments, some of all of the software steps may be installed and executed in a single computing device adequately configured to interact with remote information resources, for example, to service search requests; to collect social engagement data; and to curate a hosted document collection.

In step 202, a user, through a computing device, makes a connection to a resource network, either directly or through a service provider, in order to conduct a search for information represented as objects or URLs as described above. The user's computing device may be a desktop, laptop, tablet, smartphone, etc. In step 204, the user initiates a search for information of interest by entering a query into his computing device. For example, the computing device may be running a web browser, which connects to a hosted search service through a network connection such as the Internet. Alternatively, the user device may run some or all program components for the search service as an application or service on the user's computing device.

Typically, the user enters a free form query into a search field, or may be presented with multiple fields in an advanced search feature, or in some manner be presented with a list of topics for selection. The search engine then returns a list of URLs and/or HTML links in response to the query, ranked and listed in accord with the ranking scheme of the search service. Conventional ranking schemes tend to rank documents based on keywords and context of the document itself.

In one embodiment, the search engine may store search results in a data store, and when a query is entered by a user, the web service first checks the data store to see if the same query has been previously processed before. If so, then those prior results can be retrieved and processed for presentation to the user, or possibly supplemented by a new search that crawls the information resources for documents that are new relative to the prior results.

In one embodiment, the service described herein may be considered part of a hosted web search service that uses social engagement data to rank search results. In another embodiment, the service described herein may be considered part of a hosted curated information service that uses social engagement data to present highly relevant topical content. In both of these embodiments, a quality score is generated for search objects based on social engagement data.

In step 206, the web service receives the query, and the query is processed in step 208. In step 210, the web service ingests URLs or content feeds from blogs around the query, for example, by using a web crawler to make a systematic search on the applicable resource network(s). The ingested URLs are indexed and stored by the web service in step 212.

In step 214, the web service collects social engagement data from various social media sites for each URL identified in response to the query. For example, the number of shares, likes and discussions on Facebook, or tweets and retweets on Twitter, are active consumer engagement signals that can be collected through the API of these services for a specific URL. Similar engagement signals can be obtained from other social media networks. This step of collecting social engagement data can be performed at the same time that the service is crawling the web looking for documents.

For each object/URL identified in response to the query, the social sharing data are aggregated and processed by the web service in step 216 to provide some measure of which content is grabbing the attention and engagement of consumers. A quality score is calculated during the processing step for each document obtained or identified in response to the query. The processing step is described in more detail below.

In step 218, a ranked list of the documents is generated by the web service, the ranking based on the quality score developed in the processing step. In step 220, the ranked list of documents is presented to the user in response to the user's query. Alternatively, the ranked list may be collected into a relevant document collection that is curated for the benefit of users, for example, to maintain highly relevant collections of topical materials based on social engagement data, as discussed in more detail below. In step 222, the user views the results.

4. Processing Social Engagement Data
A. Normalizing the Social Engagement Data

Once the social engagement data for an object has been collected from the various social networks in step 210, the data may be normalized to remove audience size bias so that effective comparisons can be made between different objects identified by the search engine as relevant to the user's query. In one embodiment, normalization is accomplished simply by summing the count of all relevant “shares” identified for various social networks, and dividing the resultant sum by the number of unique users for the site divided by 1000, as shown in Equation (1) below. The relevant shares or social engagement features may be predefined and/or configurable. The number of unique users may be obtained from trusted panel-based services such as Compete.com or Comscore.com. The result is an active engagement score SPM (Shares Per Thousand) that represents the number of sharing-events per thousand unique users for each URL:

$${SPM}_{URL} = \frac{\sum ( {FB}_{Shares} , {FB}_{Likes} , {FB}_{Discussions} , {Tw}_{Tweets} , … {Pn}_{Pins} )}{( {Site}_{Unique \text{-} Visitors} / 1000 )} \qquad ( 1 )$$

B. Adding Sentiment and other Weighting Factors

The active engagement score SPM may be modified by considering other factors and weighting results accordingly. For example, since not all content shared in social media may necessarily be high quality, e.g., negative or inappropriate content may get shared as positive content, a sentiment score “σ” may be factored into the social engagement score SPM. That is, each discrete sharing event represented in the numerator of Equation (1) can be factored or weighted with a sentiment score “σ” associated with the sharing event, as shown in Equation (2) below. A sentiment score “σ” defines the polarity of appropriateness for each share, comment, etc., for example in a range from −100 (most negative) to +100 (most positive), based on a semantic analysis of the tone or attitude or context of the sharing event. Commercial sentiment analysis software is available off-the-shelf, marketed by SAS, Lexalytics, Metavana, and others, may be used to obtain a sentiment score.

Not surprisingly, content that receives the most social activity and a high positive sentiment score will be considered the content with the highest engagement and quality for search ranking and document curation in accord with the methods described herein.

This information is normalized and weighted in order to create a quality score (Quality_{URL}) for each piece of content so it can be compared and ranked. This initial ranked list of content represents a ranked list generated by consumer social engagement.

In addition, sharing and engagement events are also not equal to one another. Some events (e.g., Facebook Share vs. Facebook Like) carry more weight. As a result, weights “α” associated with each engagement event must be factored in. The result is the final quality score for each URL:

$${Quality}_{URL} = \frac{\sum ( \begin{matrix}{α}_{FBSh} , {σ}_{FBSh} , {FB}_{Shares} , {α}_{FBLi} , \\ {σ}_{FBLi} , {FB}_{Likes} … {α}_{Pin} , {σ}_{Pin} {Pn}_{Pins}\end{matrix} )}{( {Site}_{Unique \text{-} Visitors} / 1000 )} \qquad ( 2 )$$

C. Author and Publisher Quality

The ranking described above based on a weighted social engagement score is preferably used simply as an initial ranking of content around a particular topic. This ranking represents a popular vote, and may not necessarily be the best ranked list that can be produced around that topic. The opinions of “experts” help to improve the results and can be considered as well. In one embodiment, experts are defined as selected content creators, such as publishers or authors, who are considered authorities on the given topic. Experts are chosen via an editorial process taking into account their reputation, authority, and coverage around the subject matter being ranked. Experts are not necessarily equal, and Equation (3) below is one method for determining which experts produce, on average, the most engaging and high quality content, as measured through an average quality score. Thus, an expert such as an author or content creator can have their quality be determined by taking an average of quality scores for URLs featuring the expert's content over a period of time.

Expert_{Qual}=Avg(Qual_{URL-1},Qual_{URL-2}Qual_{URL-3} . . . Qual_{URL-n}) (3)

In one embodiment, experts who routinely provide the most engaging, high quality content can be assigned a higher weight, or authority score, in votes for content, and such weights can be incorporated into Equation (2). Some experts may agree to provide their content automatically via a feed in an RSS feed or Atom feed as well as provide links to their own social channel presences. Content from experts may also be ingested, normalized and scored to determine the quality of their content in order to derive a quality score for the content creator.

As noted above, experts may be given the ability to rank and vote for their best content through the use of a set number of points. For example, experts may be given 100 points per month to vote for content. These votes may then be used to sway the overall rankings for the content.

5. Curating Content

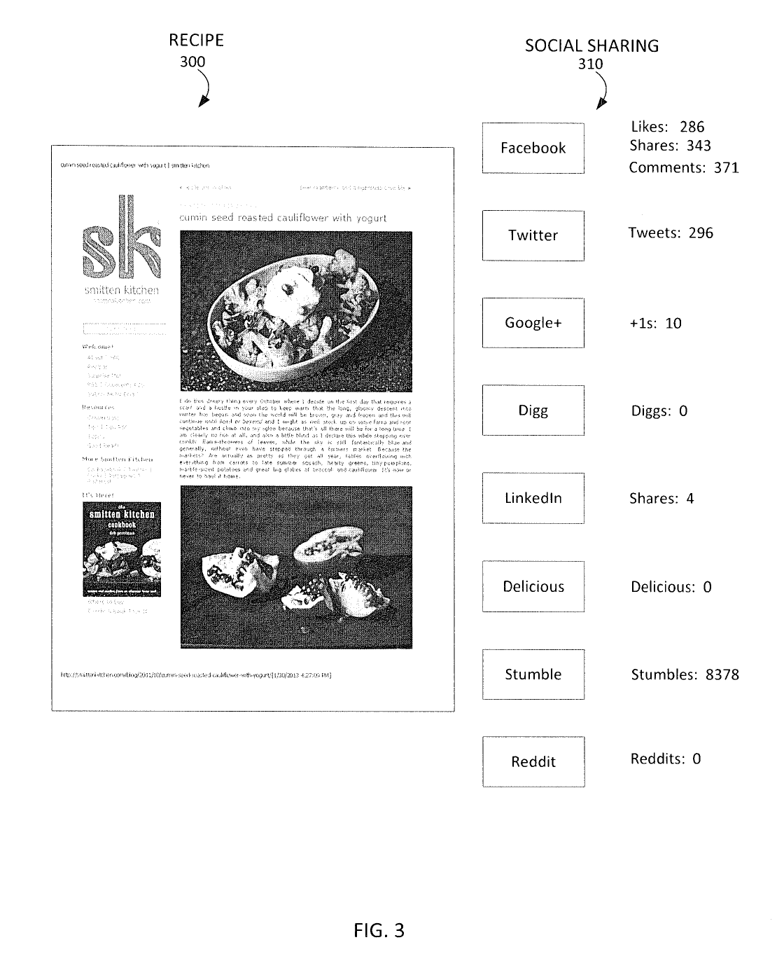

As mentioned above, in one embodiment, the ranking service described herein may be used to help build and maintain a curated information service. For example, the curated information service may be a web hosted service that provides dedicated channels for various type of information. Referring to FIG. 3, an example web page is illustrated for a recipe channel on a curated web site. The recipe was obtained during a crawl of internet resources, saved to a data store, and indexed as part of a recipe collection for the curated web site. The web page shows the actual URL, as well as the social engagement data obtained for this URL. The social engagement data may be utilized as described above to rank the recipe as among all recipes included in the recipe channel.

6. Conclusion

It should be understood that the particular embodiments of the subject matter described above have been provided by way of example and that other modifications may occur to those skilled in the art without departing from the scope of the claimed subject matter as expressed by the appended claims and their equivalents.

1. A method for ranking documents, comprising:
generating, in a memory of a computer system, a list identifying a plurality of documents that represent search results of a computer-executed query initiated by a user, each document in the list being assigned a rank by the computer system;
determining, by the computer system, the rank to assign each document on the basis of social engagement data for the document; and
presenting the ranked list of documents to a user in response to the query.

2. The method of claim 1, the determining step further comprising:
obtaining, by the computer system from a plurality of social media sites, a plurality of social engagement data for each document identified in the search results;
combining the social engagement data by the computer system thereby generating a quality score for each document; and
determining, by the computer system, the rank for each document on the basis of the quality score.

3. The method of claim 1, further comprising:
crawling social media sites to obtain social engagement data concurrently with crawling information resources to obtain search results.

4. The method of claim 2, the step of obtaining social engagement data further comprising generating a count of the number of sharing events and/or engagement events for each document on each of the plurality of social media sites.

5. The method of claim 4, the step of generating a quality score further comprising normalizing the counts from different social media sites.

6. The method of claim 5, further comprising:
for each document, summing the counts from each of the plurality of social media sites; and
dividing the sum of the counts by the number of unique visitors for each document divided by one thousand.

7. The method of claim 4, wherein the sharing events and engagement events on social media sites include shares, likes, comments, tweets, diggs, and stumbles.

8. The method of claim 6, wherein at least one weight is assigned to each sharing event and/or engagement event on each social media site, and the count for the sharing event and/or engagement event is multiplied by the weight.

9. The method of claim 8, wherein the weight is a sentiment score.

10. The method of claim 8, wherein different sharing events and/or engagement events are assigned different weights.

11. A non-transitory computer-readable medium encoded with at least one sequence of instructions which, when executed by at least one processor, causes the processor to perform the method of claim 1.

12. A method for curating a collection of documents, comprising:
generating, in a memory of a first computer system, a list identifying a plurality of documents that represent search results of a computer-executed query initiated by a curator, each document in the list being assigned a rank by the first computer system;
determining, by the first computer system, the rank to assign each document on the basis of social engagement data for the document;
storing the ranked list of documents in a data store and associating the ranked list with a topic of the query;
providing a hosted service by a second computer system, the hosted service presenting a list of topics for display by a user; and
presenting the ranked list from the second computer system to a user who selects the topic of the query.

13. The method of claim 12, wherein the first computer system and the second computer system are the same computer system.

14. The method of claim 12, the determining step further comprising:
obtaining, by the first computer system from a plurality of social media sites, a plurality of social engagement data for each document identified in the search results;
combining the social engagement data by the first computer system thereby generating a quality score for each document; and
determining, by the first computer system, the rank for each document on the basis of the quality score.

15. The method of claim 14, further comprising:
for each document, counting and summing the number of sharing events and/or engagement events from each of the plurality of social media sites; and
dividing the sum of the counts by the number of unique visitors for each document divided by one thousand.

16. The method of claim 15, wherein at least one weight is assigned to each sharing event and/or engagement event on each social media site, and the count for the sharing event and/or engagement event is multiplied by the weight.

17. A non-transitory computer-readable medium encoded with at least one sequence of instructions which, when executed by at least one processor, causes the processor to perform the method of claim 12.

18. An apparatus for ranking documents, comprising:
a processor;
one or more stored sequences of instructions which, when executed by the processor, cause the processor to carry out the steps of:
generating a list identifying a plurality of documents that represent search results of a computer-executed query initiated by a user, each document in the list being assigned a rank by the computer system;
determining the rank to assign each document on the basis of social engagement data for the document; and
presenting the ranked list of documents to a user in response to the query.
